(19) United States
(12) Patent Application Publication
(10) Pub. No.: US 2024/0375079 A1
(43) Pub. Date: Nov. 14, 2024

(54) 3D HIERARCHICAL NANOPOROUS GRAPHENE MEMBRANE FOR OIL/WATER SEPARATION

(71) Applicant: Khalifa University of Science and Technology, Abu Dhabi (AE)

(72) Inventors: Shadi Wajih HASAN, Abu Dhabi (AE); Fawzi BANAT, Abu Dhabi (AE); Ahmed Mamdouh Mahmoud ELMEKAWY, Abu Dhabi (AE); Hanaa Mohamed Samy Mohamed Saber HEGAB, Abu Dhabi (AE)

(21) Appl. No.: 18/195,124

(22) Filed: May 9, 2023

(51) Int. Cl. B01J 20/24; B01D 69/02; B01D 69/12; B01D 69/14; B01D 71/02; B01D 71/82; B01J 20/20; B01J 20/28; B01J 20/32; C02F 1/44

(52) U.S. Cl. CPC B01J 20/24; B01D 69/02; B01D 69/125; B01D 69/14; B01D 71/0211; B01D 71/82; B01J 20/205; B01J 20/28035; B01J 20/28083; B01J 20/3217; B01J 20/3278; C02F 1/44; B01D 2323/12; B01D 2323/36; B01D 2323/40; B01D 2325/02831; B01D 2325/36; B01D 2325/38; C02F 2101/32

(57) ABSTRACT

A multi-functionalized NPG nanosheet can be used to form a 3D hierarchical multi-functionalized NPG membrane (NPG-pTD membrane) for use in oil/water separation. The NPG-pTD membrane includes a plurality of multi-functionalized NPG nanosheets in a stacked assembly with polyphenolic nanoparticles attached to the NPG nanosheets throughout the membrane. The NPG-pTD membrane can be formed via in-situ polymerization, which is vacuum assisted, such that the phenolic compounds from the multi-functionalized NPG nanosheet form the nanoparticles. Interlayer d-spacing between the adjacent nanosheets in the stacked assembly creates expansive and constricted channels, in addition to nanochannels provided by the pores in the nanosheets, such that the membrane has aquaporin-like properties. The NPG-pTD membrane exhibits high permeability and flux and superior selectivity for effective oil/water separation.

### BACKGROUND

The intensifying industrial activity and the high population growth have resulted in the global growth of urbanization, putting pressure on clean water demands and leading to freshwater supply shortages. Wastewater contaminated with oil, normally produced by several industrial sectors, has become a serious daily environmental issue. Oil/water nano-emulsions (stabilized by surfactants), with droplet sizes 20-200 nm, are generally produced by numerous industries, i.e., cosmetics, oil refineries, food, and pharmaceutical. These nano-emulsions can lead to health and environmental issues due to their high stability and conveyance in the environment, leading to potential eco-toxicity because of the surfactants' powerful biological reactivity.

The oil/water nano-emulsion separation process remains a challenge due to the co-occurrence of small surfactant molecules along with nano-oil droplets. The conventional technologies (i.e., gravity separation, skimming, air flotation, and centrifugation) are still not functional in the efficient removal of surfactant/emulsified oil from the nano-emulsion. Based on the size exclusion principle, membrane separation is one of the most encouraging technologies to tackle the challenge of nano-emulsion separation. Hydrophobic membranes have been employed in the separation process of water-in-oil nano-emulsion, supporting the passage of oil and repulsion of water by the membrane. However, hydrophobic membranes possess some challenges regarding the low flux of the viscous oil (Hagen-Poiseuille equation), and oil fouling due to the membrane hydrophobicity.

It would be beneficial to develop a membrane for oil/water separation that has high permeability, high flux, and superior selectivity.

### SUMMARY

According to one aspect, a multi-functionalized NPG nanosheet includes a nanoporous graphene (NPG) nanosheet modified with a polyphenolic and a catecholamine to form the multi-functionalized NPG nanosheet in which the polyphenolic and the catecholamine attach to the NPG nanosheet.

According to another aspect, an NPG membrane includes a plurality of multi-functionalized NPG nanosheets, the multi-functionalized NPG nanosheets formed by attaching a polyphenolic and a catecholamine to an NPG nanosheet. The plurality of multi-functionalized NPG nanosheets are arranged in a stacked assembly in the membrane. The NPG membrane further comprises a plurality of polyphenolic nanoparticles attached to the membrane and among the stacked assembly of multi-functionalized NPG nanosheets.

According to another aspect, a method of making an NPG membrane includes arranging a plurality of multi-functionalized nanoporous graphene (NPG) nanosheets into a stack, the NPG nanosheets functionalized with phenolic compounds. The method further includes forming nanoparticles from the phenolic compounds such that the nanoparticles are attached to the membrane and to the nanosheets.

This summary is intended to provide an overview of subject matter of the present disclosure. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed herein.

FIG. 1 is a schematic of a process for preparing functionalized NPG nanosheets.

FIG. 2 is a schematic of a process for preparing 3D hierarchical multi-functionalized NPG-pTD membranes.

FIG. 3A is a schematic depicting the unique features of an aquaporin channel.

FIG. 3B is an SEM image of the aquaporin-like 3D hierarchical NPG-pTD membrane.

FIG. 3C is a schematic depicting a cross section of a portion of the 3D hierarchical NPG-pTD membrane to illustrate the tripartite nanochannels.

FIG. 4 is a flowchart illustrating a method of making a 3D hierarchical NPG-pTD membrane.

FIG. 5 is a flowchart illustrating a method of using a 3D hierarchical NPG-pTD membrane for separation of oil and water.

FIG. 6A is a TEM image of prepared GO nanosheets.

FIG. 6B is an AFM image of GO nanosheets.

FIG. 6C is a TEM image of synthesized NPG nanosheets.

FIG. 6D is an AFM image of NPG nanosheets, including pore and height profiles.

FIG. 7 is a plot of FTIR spectra of GO and NPG membranes.

FIG. 8 is a photo of various membranes, including NPG-pTDX membranes.

FIG. 9 is a plot of FTIR spectra of various membranes, including NPG-pTDX membranes, and includes magnified peaks.

FIG. 10 is a plot of contact angle of various membranes, including NPG-pTDX membranes.

FIG. 11 shows SEM images and EDS surface elemental mapping of a support layer and various membranes, including NPG-pTDX membranes

FIG. 12 shows cross-sectional SEM images of a support layer and various membranes, including NPG-pTDX membranes.

FIG. 13 is a plot of XRD analysis of various membranes.

FIG. 14 are plots of performance results of various membranes for oil and water separation.

### DETAILED DESCRIPTION

The present disclosure is directed to a 3D hierarchical multi-functionalized nanoporous graphene (NPG) membrane with tripartite nanochannels (NPG-pTD membrane). The NPG-pTD membrane is comprised of a plurality of modified or multi-functionalized NPG nanosheets in a stacked assembly and a plurality of polyphenolic nanoparticles attached to the surface of the membrane and throughout or among the stacked assembly of nanosheets. The NPG-pTD membrane can be formed via an in-situ polymerization/vacuum-assisted strategy. The tripartite nanochannels, as that term is used herein, can refer to three functioning channels within the NPG-pTD membrane: (1) the nanochannels created by the pores in the NPG nanosheets; (2) expansive interlayer spacing. and (3) constricted interlayer spacing. As used herein, NPG-pTD refers to a multi-functionalized NPG membrane having pTD nanoparticles attached to the NPG nanosheets throughout the membrane.

The interlayer d-spacing of the multi-functionalized-NPG nanosheets or nanolayers in the NPG-pTD membrane is responsible, at least in part, for the effective performance of the NPG-pTD membrane in oil and water separation. The NPG-pTD membrane disclosed herein exhibited aquaporin-like 3D structure and functionality which led to successful purification of a surfactant stabilized oil/water emulsion. The NPG-pTD membrane displayed both elevated permeability and superior selectivity. Consequently, the NPG-pTD membrane achieves a higher flux than a graphene oxide (GO) membrane, while the oil rejection of the NPG-pTD membrane is 96% or more.

Graphene oxide (GO) has been used in ultrafiltration membranes for the separation of oil and water. On its border and basal plane, graphene oxide (GO) comprises a significant amount of oxygenic reactive groups. It also possesses unique features, i.e., an accessible interface, great surface area, and ultrafast shuttling properties. It was earlier discovered in 2007 that paper-like GO-based membranes had selectivity potential. Water can travel through the GO-based membranes' wrinkled interlayer space and sheets with nanochannels all over them while other molecules larger than the distance between adjacent GO nanosheets are effectively blocked. Additionally, the hydrophilic properties of GO make it possible to fabricate membranes for the separation of oil-in-water emulsions. Accordingly, several GO-coated membranes have been fabricated for this purpose, i.e., sulfonated GO/TiO₂ spheres, GO/Al₂O₃ microfiltration (MF) and GO ultrafiltration (UF) membranes, showing efficient separation capacity. Nevertheless, the instability of GO membranes fabricated using porous MF support was reported owing to the weak interaction with the supporting surface resulting in the development of crinkles and detachment from the surface.

The biological cell membrane, which is made up of proteins, lipids, and hydrophilic polymers, functions as a wall separating the interior of the cell from its external world, providing security and regulating the flow of molecules and ions out and into the cell. Aquaporin proteins are the core component of the cell membrane, functioning as regulating channels for the flow of water, ions and various solutes, due to their hydrophobic nature. Moreover, the scarcity of water binding sites in aquaporins accelerates water transport, and the availability of ion binding sites and steric effects contribute towards the efficient transport control of ions and solutes. In addition, the steric barrier and the development of a surface layer of repulsive hydration on the cell membrane are some of the processes by which the brush-shaped hydrophilic polymers of the cell membrane can act as a shield.

The multi-functionalized NPG nanosheets disclosed herein show superior performance when used in an NPG-pTD membrane for oil/water separation. as compared to existing GO-based membranes. The NPG-pTD membranes disclosed herein exhibited aquaporin-like functionality.

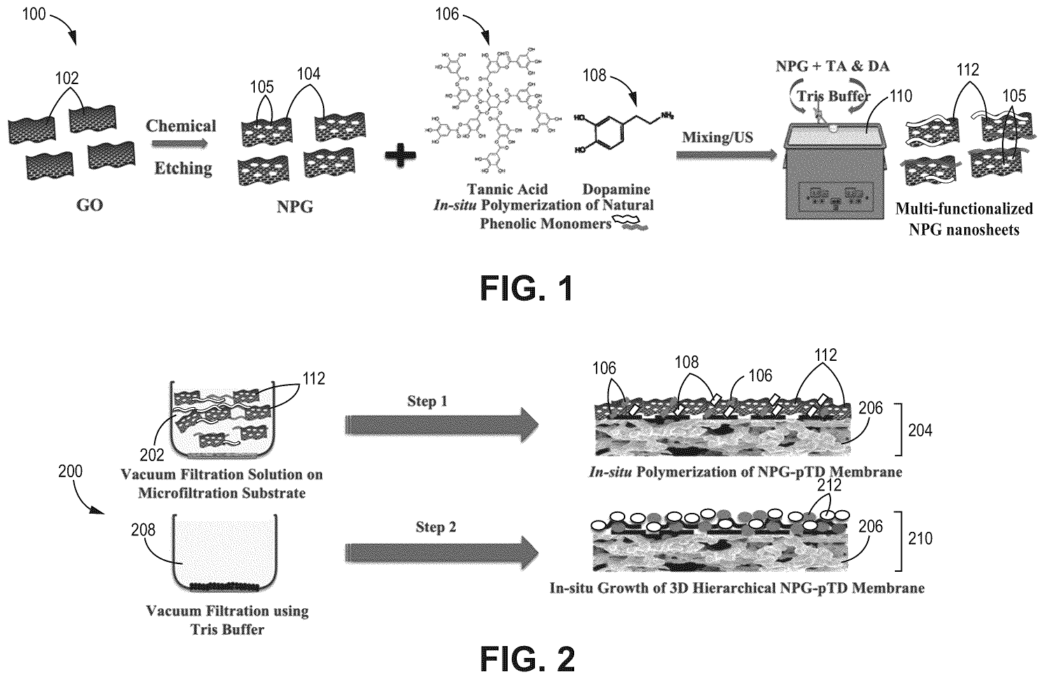

Multi-functionalized NPG nanosheets: FIG. 1 illustrates a process 100 for forming modified or multi-functionalized NPG nanosheets. (In reference to the NPG nanosheets, the terms “modified” or “multi-functionalized” are used interchangeably here.) The process 100 can include starting with graphene oxide (GO) nanosheets 102 and chemically etching the GO nanosheets 102 to form nanoporous graphene (NPG) nanosheets 104. Each nanosheet 104 can include a plurality of pores 105. In some embodiments, the GO nanosheets 102 can be part of a GO dispersion.

Next, the NPG nanosheets 104 can be exposed to tannic acid (TA) 106 and dopamine (DA) 108 such that there is in-situ polymerization of these natural phenolic monomers. At ultrasonication 110, NPG nanosheet 104, TA 106 and DA 108 can be combined with tris buffer. The result following ultrasonication 110 is multi-functionalized or modified NPG nanosheets 112 which are functionalized by the attachment of TA and DA to the nanosheet 104 during the process 100. At the end of the process 100 of FIG. 1. the nanosheets 112 can be kept in the tris buffer solution.

Tannic acid (TA) is an example of a phenolic acid that can be used in forming the multi-functionalized NPG nanosheets 112. It is recognized that other phenolic acids can be used under the process 100. Dopamine (DA) is an example of a catecholamine that can be used in forming the multi-functionalized NPG nanosheets 112. It is recognized that other types of catecholamines can be used under the process 100.

In some embodiments, TA 106 and DA 108 are used in similar amounts in forming the multi-functionalized NPG nanosheets 112 such that a weight ratio of TA to DA in the process 100 is about 1:1. In other embodiments, more or less TA can be used relative to DA. In some embodiments, a volume ratio of TA to DA to NPG nanosheet 104 can be between about 5:5:1 and about 100:100:1. In some embodiments, the volume ratio of TA to DA to NPG nanosheet 104 is about 100:100:1.

The multi-functionalized NPG nanosheet 112 is a porous structure having a plurality of pores 105. In some embodiments, the nanopores 105 are of a size (i.e. a diameter) ranging between about 10 nm and about 25 nm. In some embodiments, the pore size is between about 18 nm and about 22 nm. In some embodiments, a thickness of the multi-functionalized NPG nanosheet 112 is about 0.8 nm. In some embodiments, a lateral dimension of the multi-functionalized NPG nanosheet 112 is between about 500 and about 1000 nm.

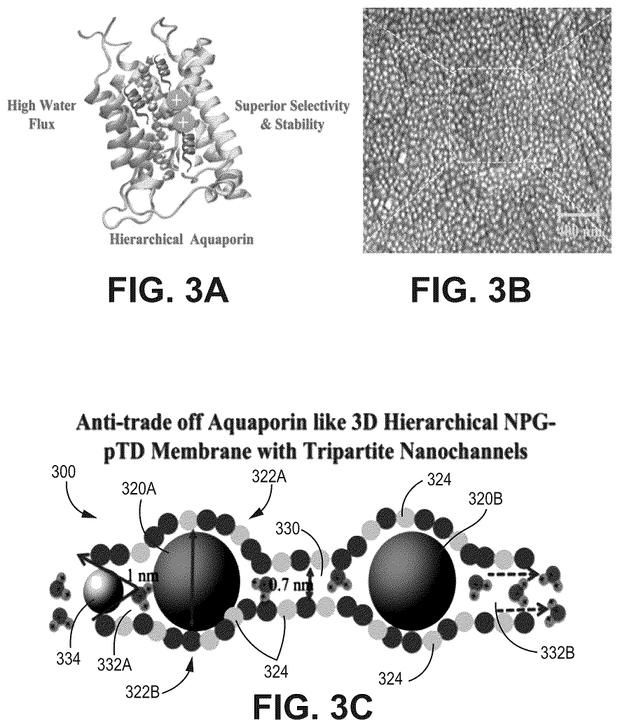

NPG-pTDX membranes: FIG. 2 illustrates a process 200 for forming a 3D hierarchical NPG-pTDX membrane. The process 200 starts with a plurality of multi-functionalized NPG nanosheets 112 from the process 100 of FIG. 1. The multi-functionalized NPG nanosheets 112 can be in a tris buffer solution 202. In step 1 of in-situ polymerization under vacuum filtration under the process 200, the DA and TA molecules adhere to the NPG nanosheets 112 via stacking and hydrogen bonding. Thus, the protonated TA and DA can attach to the oxygen functional groups on the NPG nanosheets 112. The NPG nanosheets 112 are self-stacking such that the nanosheets or nanolayers 112 form a stacked assembly in which numerous nanosheets/nanolayers 112 are stacked relative to one another.

FIG. 2 shows an NPG-pTD membrane 204 after step 1. The membrane 204 includes a support layer 206 and the nanosheets 112 covering the support layer 206 to form the membrane 204. As also shown in FIG. 2, the phenolic compounds of TA 106 and DA 108 are shown attached to the nanosheets 112 and the nanosheets 112 form the stacked assembly.

The support layer 206 is a permeable material that the nanosheets/nanolayers 112 attach to for formation of the membrane 204. The support layer 206 can be any type of hydrophilic support material. In some embodiments, the support layer 206 can be a nitrocellulose material, such as nitrocellulose mixed ester.

In step 2, also performed under vacuum filtration and in-situ polymerization, the membrane is placed in a solution of tris buffer, pH>8.5 at 208 and the in-situ polymerization reaction is completed, resulting in growth of a self-assembled 3D hierarchical NPG-pTD membrane 210. The growth under step 2 can include the formation of a plurality of self-assembled nanoparticles 212, formed from the phenolic compounds 106 and 108. The nanoparticles 212 can also be referred to herein as pTD nanoparticles.

In some embodiments, steps 1 and 2 can be performed at room temperature. In some embodiments, after the membrane 210 is formed in step 2, the membrane 210 can be dried at about 70 degrees Celsius.

The membrane is given a new reference number (210) after step 2, distinguishable from the membrane 204, because the structure is different relative to the membrane 204 after step 1. The difference in structure is due to the formation of the nanoparticles 212 within the stacked assembly of the nanosheets 112.

In some embodiments, the presence or amount of the nanoparticles 212 in the membrane 210 after step 2 can depend on a loading concentration of the multi-functionalized NPG nanosheets 112 in the membrane 210. The 3D hierarchical NPG-pTD membrane 210 can be referred to as NPG-pTDX, where ‘X’ refers to the loading concentration of the multi-functionalized NPG nanosheets 112, with an increasing value for ‘X’ correlating to higher nanosheet loading. In some embodiments, the loading concentration is between about 5 and about 1000 μg/cm². In some embodiments, the loading concentration is between about 5 and about 50 g/cm². In some embodiments, the loading concentration is between about 50 and about 1000 μg/cm². In some embodiments, the loading concentration is between about 65 and about 225 g/cm². In some embodiments, the loading concentration is at least 150 μg/cm². In some embodiments, the loading concentration is at least 200 g/cm².

In some embodiments, a size (diameter) of the nanoparticles 212 can range between about 2 and about 20 nm. In some embodiments, the diameter can range between about 4 and about 10 nm. In some embodiments, the diameter can range between about 5 and about 7 nm.

In some embodiments, a thickness of the membrane 210 can range between about 200 and about 700 nm. In some embodiments, the membrane 210 can include between about 250 and about 500 nanosheets or nanolayers. The nanosheets/nanolayers are generally stacked with one another to form a stacked assembly. The thickness of the membrane and the number of nanosheets in the membrane can be dependent on one another. For example, an increase in the thickness of the membrane is typically a result of more nanosheets or nanolayers. The thickness and number of nanosheets/nanolayers in the membrane can also depend, at least in part, on the loading concentration.

The effectiveness of the membrane 210 for oil/water separation (in terms of selectivity and flux) can be attributed to a d-spacing of the nanosheets/nanolayers in the membrane 210. The d-spacing refers to channels created between adjacent nanosheets in the membrane 210. In some embodiments, there can be two types of channels between nanosheets in the stacked assembly—wide channels and narrow channels, as described further below. One of the benefits of the design of the membranes disclosed herein is that there are multiple channel types. In addition to wide and narrow channels, the pores (see pores 105 of FIG. 1) on the nanosheets 104/112 can also act as channels in the NPG-pTD membrane and can constitute a third type of channel in the membrane system.

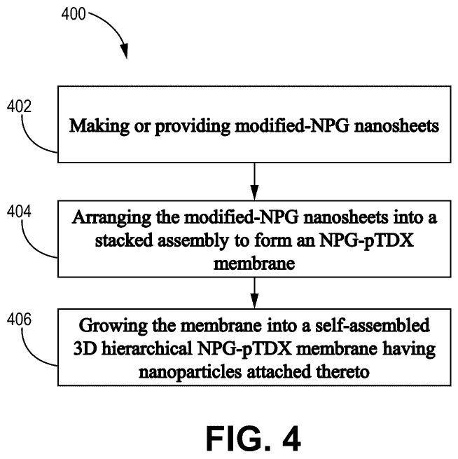

As described above, the 3D hierarchical NPG-pTD membranes disclosed herein have aquaporin-like channels and functionality. FIG. 3A is a schematic illustrating the unique features of the aquaporin channel for biological cell membranes, for comparison purposes only. FIG. 3B is an SEM image of the aquaporin-like 3D hierarchical NPG-pTD membrane. FIG. 3C is a schematic of a cross section of a portion of an NPG-pTD membrane 300 formed through the processes 100 and 200 of FIGS. 1 and 2, respectively.

FIG. 3C shows a first nanoparticle 320A and a second nanoparticle 320B (also referred to as pTD nanoparticles) formed between a first nanosheet or nanolayer 322A and a second nanosheet or nanolayer 322B. In the first and second nanosheets 322A, 322B, the light-colored spheres represent nanopores 324 formed in the nanosheets 322A, 322B and the darker spheres represent the nanosheet itself. A constrictive channel 330 is formed between adjacent nanosheets 322A and 322B in the lateral space between the nanoparticles 320A and 320B. The constrictive channel 330 is also referred to as compact, tight, or narrow. In some embodiments, a length of the constrictive channel 330 is about 0.7 nm, which correlates to a d-spacing of about 0.7 nm. A wide channel 332A is formed between adjacent nanosheets 322A and 322B on an opposite side of the nanoparticle 320A relative to the constrictive channel 330. Similarly, a wide channel 332B is formed on an opposite side of the nanoparticle 320B relative to the constrictive channel 330. The wide channel 332B is also referred to as an expansive or large channel. In some embodiments, a length of the wide channels 332A and 332B is about 1.0 nm, which correlates to a d-spacing of about 1.0 nm. The wide channels 332A and 332B allow for water to pass therethrough. FIG. 3C shows a water molecule 334 passing through the wide channel 332A. The constrictive channel 330 improves selectivity of the membrane 300.

The structure and pattern of FIG. 3C can repeat across the NPG-pTD membrane 300 and between adjacent nanosheets or nanolayers in the stacked assembly. The wide channels 332A. 332B can refer to hydrophilic d-spacing regions and the constrictive or tight channel 330 can refer to hydrophobic graphitic d-spacing regions. This membrane system of alternating hydrophobic and hydrophilic regions contributes to the superior performance of the membrane 300 for effective oil and water separation.

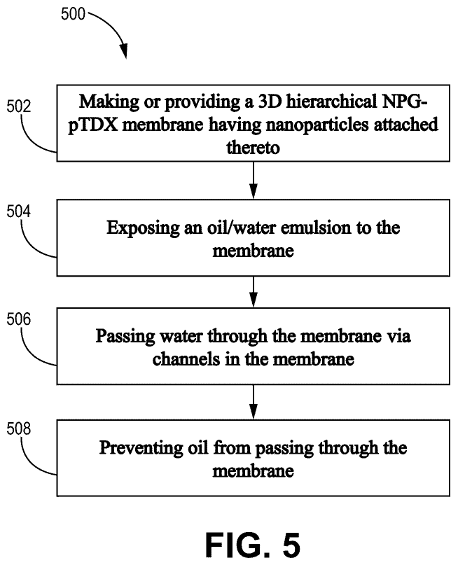

FIG. 4 is a flowchart illustrating steps in a method 400 to make a 3D hierarchical NPG-pTD or NPG-pTDX membrane. At step 402, modified or multi-functionalized NPG nanosheets can be made or provided. The NPG nanosheets are functionalized or modified via the attachment of phenolic monomers/compounds, such as, for example, tannic acid and dopamine hydrocholoride. The process for making the multi-functionalized or modified NPG nanosheets is further described above in reference to FIG. 1 and also in the Examples section below under Example 1. At step 404, the modified or multi-functionalized NPG nanosheets can be arranged into a stacked assembly. The phenolic monomers/compounds attached to the NPG nanosheets facilitate stacking of a plurality of NPG nanosheets to form the membrane under in-situ polymerization. At step 406, the membrane is grown into a 3D hierarchical NPG-pTDX membrane having nanoparticles attached thereto. The nanoparticles are formed from the phenolic compounds via in-situ polymerization. Steps 404 and 406 are further described above in reference to FIG. 2 and also in the Examples section below under Example 2.

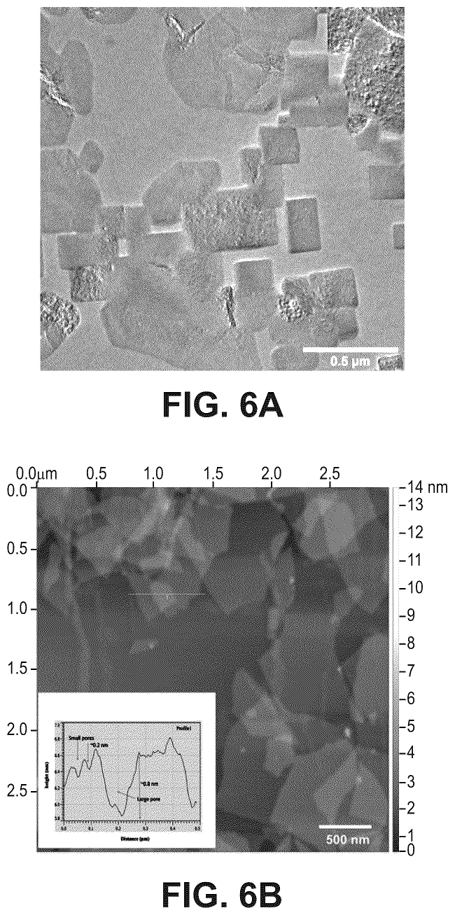

FIG. 5 is a flowchart illustrating steps in a method 500 to separate oil and water in an oil/water emulsion using an NPG-pTD membrane. At step 502, a 3D hierarchical NPG-pTDX membrane is made or provided. The NPG-pTD membrane includes nanoparticles attached thereto that are formed from phenolic compounds. At step 504, an oil/water emulsion can be exposed to the membrane such that water passes through the membrane at step 506 via channels formed in the membrane. At step 508, oil is prevented from passing through the membrane. The hydrophilic nature of the membrane's surface blocks oil from passing through the membrane and the tight/constrictive channels improve the membrane's selectivity.

In some embodiments, the NPG-pTD membranes disclosed herein have an oil removal ability of at least 70. In some embodiments, the oil removal ability is at least 80% or at least 95%. The performance of the NPG-pTD membranes for separating oil and water is described below under Example 4.

The permeability of the NPG-pTD membrane can increase as a function of the loading concentration of the multi-functionalized NPG nanosheets or nanolayers. This may be due to the growth of the hydrophilic 3D hierarchical pTD nanoparticles among the NPG nanosheets. In some embodiments, the loading concentration of the nanosheets in the membrane is at least 150 g/cm². In some embodiments, the loading concentration is at least 200 μg/cm².

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### EXAMPLES

### Materials

All chemicals used in the Examples below were obtained from Sigma-Aldrich™: graphite powder with a size of 10 mesh, phosphoric acid (H₃PO₄, 85%), sulfuric acid (H₂SO₄, 96%), hydrochloric acid (HCl, 36%), ethanol (95%), H₂O₂ (35%), potassium permanganate (KMnO₄, 99%), ammonium hydroxide solution (NH₄OH), sodium hydroxide, tris buffer, dopamine hydrochloride (DA, C₈H₁₁NO₂·HCl, 98%) and tannic acid (TA, C₇₆H₅₂O₄₆). Advantec provided the 0.22 micron, 47 mm diameter nitrocellulose mixed ester MF support used in this study, and widely available vegetable oil was also used. A purification device was used to provide the deionized (DI) water (Millipore Milli-Q Plus 185-15 MΩ·cm at 25° C.).

### Characterization of Synthesized Nanosheets and Membranes

An atomic force microscope (AFM Bruker Dimension Icon with ScanAsyst, Bruker, Germany) was used to measure the thickness of the GO and NPG nanosheets in tapping mode. The dispersed solutions of GO or HG were applied to a mica substrate from Ted Pella, Inc. in Redding, California, and allowed to air dry. GO and HG nanosheets' high-resolution images were captured by transmission electron microscopy (TEM, Titan, Thermo Fisher Scientific, 300 kV). High-resolution scanning electron microscopy (SEM) was also used to examine the manufactured membranes' surfaces and cross-sectional morphologies (FEI Nova NanoSEM 650). The sample preparation for SEM included the deposition of a 5 nm gold-palladium coating layer on all membrane samples to avoid charging and improve imaging quality. Additionally, samples were frozen and quickly fractured as part of the freeze-fracture method, which was used to prepare samples for cross-sectional analysis. All the prepared samples were positioned in the SEM stubs using adhesive carbon tape.

Energy dispersive X-ray (EDS) spectroscopy was used to trace the elements present in the synthesized membranes. Several acceleration voltages were used. Additionally, ATR-FT-IR spectroscopy (Bruker Vertex 80v spectrometer, wavelength=400-4000 cm⁻¹ and precision=4 cm⁻¹) was used to examine the surface functional groups of the membranes. All samples were scanned 64 times. The X-ray diffraction (XRD) analysis was performed using Cu Kα radiation (λ=0.154 nm, PANalytical Empyrean) to evaluate the manufactured membranes as well. All measurements were made using an angular (2θ) range of 5° to 70° while the XRD was run at 40 kV tension and 35 mA current. The Zetasizer 7.13 (Malvern Panalytical Instruments Ltd.) was used to analyze the surface charge of the nanomaterial in DI water (0.1 mg/mL) at a pH of 6.4±0.2. Water contact angle (WCA, Krüss GmbH's Drop Shape Analyzer, DSA), which uses the sessile drop technique to deposit water droplets on the top of the manufactured membranes at room temperature, was employed to determine the hydrophilicity nature of the membranes. The test was conducted five seconds before water droplets (5 μL) were deposited on the membrane surface, and the average of five measurements was then computed.

A dead-end vacuum filtration system (area=14.5 cm² under pressure (0.8 bar) and 200 mL feed solution) was employed at room temperature to test the permeance and surfactant stabilized oil/water emulsion separation capability of the manufactured membranes. The SDS surfactant and oil (1000 ppm) were initially added into DI water consecutively with a mass ratio of 0.15 (surfactant/oil) under mechanical blending. To achieve the initial emulsification, the combination was then sonicated in a Branson ultrasonic bath for two hours at a power level of 70 Watts. To intensify the emulsification, this emulsion was exposed to tip sonication (Vibra Cell™) at 750 Watts for 15 minutes.

Prior to filtration experiments, the membranes were soaked in the feed solutions. The permeance measurement started by stabilizing the obtained values under one bar, followed by recording the values every 10 min at 0.8 bars. A UV-Vis spectrophotometer was used to determine the oil concentration (Shimadzu, Japan). The average of three measurements was used to create all the statistics. According to equations (1) and (2), the permeance (J, L/m²·h·bar) in addition to rejection (R %) were determined, respectively.

$$J = \frac{V}{A Δ tP} \qquad ( 1 )$$

$$R = 1 - \frac{C p}{C f} \times 100 \% \qquad ( 2 )$$

where P (0.8 bar) is the applied pressure, Δt (h) is the permeate duration, V (L) is the volume of permeated water, A (m²) is the effective membrane area, Cp and Cf refer to the concentrations of the permeate and feed solutions, correspondingly.

### Example 1—GO Nanosheets and Multi-Functionalized NPG Nanosheets

The preparation of GO nanosheets was carried out using the simplified method of Hummer from graphite flakes. (See Marcano, D.C. et al. Improved synthesis of graphene oxide, ACS Nano 4, 4806-4814 (2010).) In brief, the flakes along with KMnO₄ (1:6) were cautiously added to the H₂SO₄/H₃PO₄ solution (1:9) in an ice bath to keep the exothermic reaction under control. Complete oxidation was accomplished by stirring the mixture for 72 h at 35° C. before being placed once more in an ice bath. Afterwards, the mixed solution was steadily diluted with two amounts of DI water: 250 mL at <35° C. and 500 mL. H₂O₂ solution (35%) was cautiously added to stop the reaction by removing the unreacted KMnO₄. The supernatant was removed after filtering the produced solution. To achieve a pH of 6.8, the gathered GO was washed with HCl solution and DI water. By ultrasonically distributing the GO yield in DI water, it was then kept.

NPG was prepared from the synthesized GO dispersion (˜2 mg/mL). The H₂O₂ and NH₄OH mixture was gradually introduced to the GO dispersion (5:5:1). To finish the etching process, the mixture solution was then kept in an oil bath (55° C.) with magnetic stirring at 30 rpm for one hour. The etched GO solution was subjected to centrifugation at 12,000 rpm (90 min) to separate the leftover reactants and products and the supernatant was discarded. To produce a single-layered, uniformly sized NPG, the resulted dispersion was centrifuged again at 3000 rpm for 10 minutes to remove unexfoliated and noticeably large NPG sheets. The diluted precipitate with tris buffer was then ultrasonicated after the addition of DA and TA. In order to facilitate the attachment of DA and TA on NPG nanosheets with a final ratio of 50:50:0.5, respectively, the combination was then stirred for 20 min at room temperature.

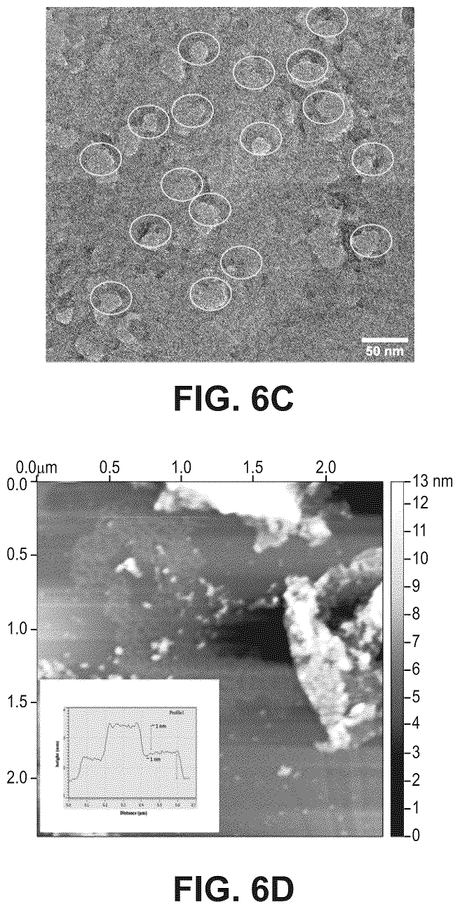

While NPG nanosheets were produced using an oxidative etching technique using a combined H₂O₂ and NH₃ solution, GO nanosheets were produced through chemical oxidation along with graphite exfoliation (FIG. 1). To control the porosity of the GO nanosheets, the unstable oxidized sp³ portions were etched during the first hour of the reaction. The TEM morphologies of GO and NPG are illustrated in FIG. 6A, in which the synthesis of nanosheets was confirmed by the presence of wrinkled GO with lateral sizes ranging from 0.5-1 μm. Furthermore, nanopores were visualized on the NPG nanosheets using the high-resolution TEM (HR-TEM) with a minimum pore size of 11.3±0.4 and a maximum of 20±3 nm after utilizing the 60 min etching time (FIG. 6C).

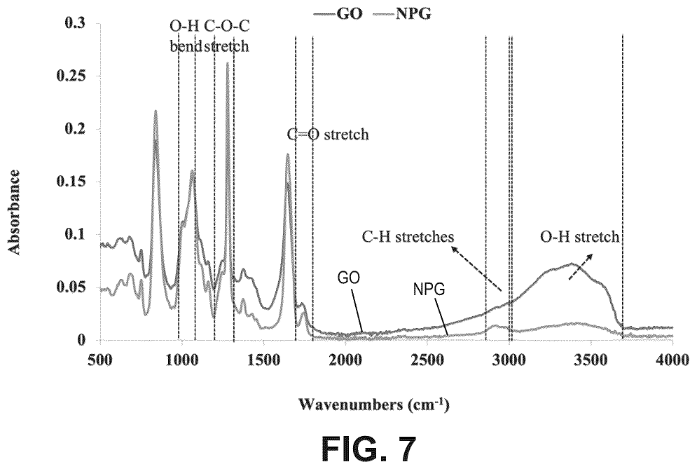

Moreover, the occurrence of single-layer GO along with NPG nanosheets was verified by examining their topographies via AFM. The GO nanosheets were confirmed to be non-porous with a thickness of 1.25 nm (FIG. 6B). The nanosheets' lateral size was noticed to be uniform and in the range of 500 to 1000 nm. Oppositely, the NPG nanosheets were observed to have a small pore size (20 nm), and a thickness of 0.8 nm (FIG. 6D). Because of the existence of —COC, —OH and C═O groups, the GO nanosheets exhibited a negative zeta potential (−45.2±0.9 mV). Prior to etching, the net charge of the NPG shifted to −2.3±0.2 mV, which is regarded as additional proof of the fractional reduction of NPG by means of NH₃ (FIG. 7).

FTIR spectra displayed the distinctive functional groups related to GO (FIG. 7), showing O—H stretching peaks (3750-3000 cm⁻¹), asymmetric and symmetric C—H stretching peaks (3000 and 2850 cm⁻¹) and C—O stretching peaks (1747 cm⁻¹). Additionally, the peak at 1250 cm⁻¹ indicates the presence of the O—C—O stretch, and the O—H bend was indicated at 1025 cm⁻¹. NPG nanosheets showed identical peaks and functional groups in the same range, except for the decrease, noted in the intensity of the peak in the range of 3750-3000 cm⁻¹, which indicated the occurrence of partial reduction.

The OH ratio was significantly diminished compared to that of pure GO. The amino fractions are attached to the NPG sheets under the alkalinity of NH₃ through the SN₂ nucleophilic dislocation interaction of the GO's functional groups of epoxy with NH₃. The C—H stretching peak's weakness was also seen in the NPG spectrum, and this can be attributed to the fact that NPG is made mainly by ordered chemical etching, which creates holes, followed by partial reduction. The results stated above confirmed that the GO was successfully synthesized, oxidized, and the NPG nanosheets were successfully etched. The obtained FTIR spectrum of the synthesized nanomaterials is in agreement with previous studies.

### Example 2—NPG-pTDX Membranes

Utilizing GO and NPG (71 μg/cm²) along with various concentrations/loading (71, 142, and 212 μg/cm²) of the multifunctional NPG solution on the surface of microfiltration support, the fabrication of membranes was done using the vacuum filtration technique (FIG. 2). The membranes were NPG-pTDX-coded, where “X” stands for the various loadings. The support was soaked in DI water prior to the deposition process. The amount of NPG or multifunctional NPG in the solution and the coating area was used to calculate the coating layer thickness. Finally, 10 mL tris buffer solution (10 mM, pH 8.5) was filtrated through the fabricated membranes (NPG-pTD1, NPG-pTD2, and NPG-pTD3), which were then dried at 70° C. overnight.

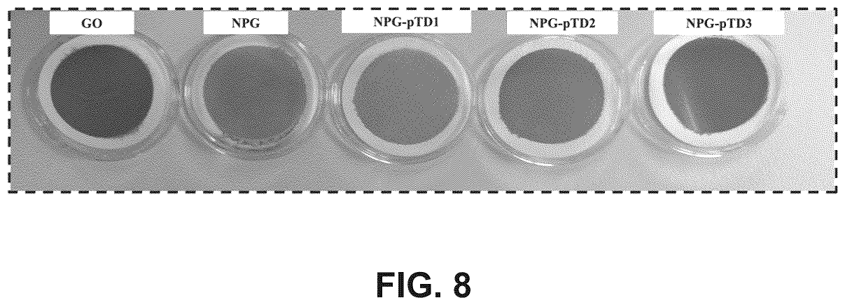

To prevent the polymerization of various phenolic groups during the modified synthesis process, TA and DA were combined with NPG (0.02 mg/mL) in tris solution without the pH being changed. Through hydrogen bonding and π-π stacking, the protonated TA and DA adhered to the oxygen functional groups of NPG. The mixture was stirred to obtain a uniform spreading of TA and DA within the NPG nanosheets and was subsequently filtered with various loadings on the surface of the support. With a loading of 71 μg/cm², multifunctionalized NPG nanosheets uniformly and flawlessly covered the permeable support (FIG. 2). The fabricated membrane was coded as NPG-pTDX, obtained after the completion of the in-situ polymerization with tris buffer (pH 8.5) different membranes with various loadings (NPG-pTD1, NPG-pTD2 and NPG-pTD3). The in-situ development of multi-functionalized polyphenolic nanoparticles can be achieved on the surface as well as through the interlayer d-spacing of the NPG nanosheets using TA and DA as phenolic precursors. The prepared membranes showed the brown and grey colours of GO and NPG control membranes, respectively (FIG. 8), while the different partially reduced membranes (NPG-pTD₁, NPG-pTD₂ and NPG-pTD₃) displayed a brown colour gradually getting darker in proportion to loading.

### Example 3—Characterizations of the 3D Hierarchical NPG-pTDX Membranes

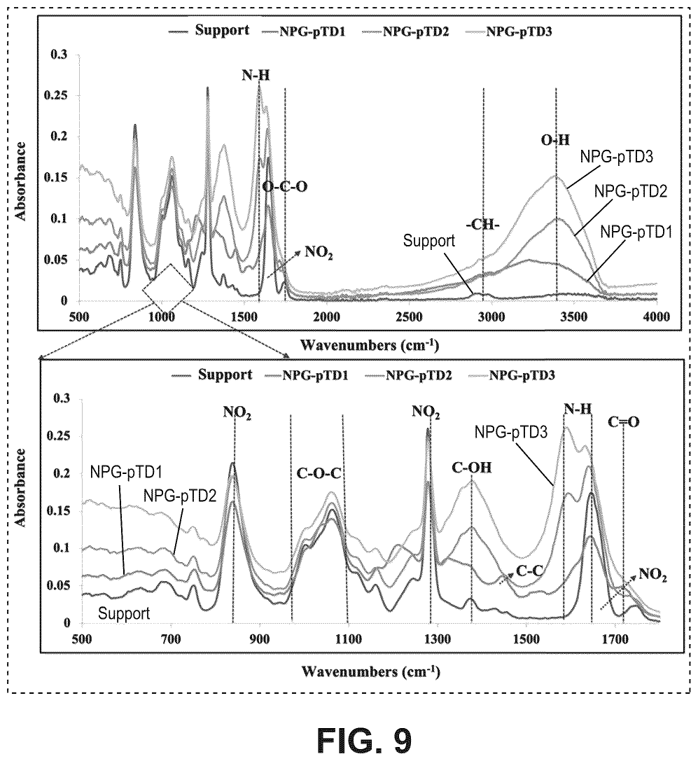

ATR-FTIR tests were carried out to define the chemical functional groups on the surface of the prepared membranes. The FTIR spectra of the support and NPG-pTD1, NPG-pTD2 and NPG-pTD3 membranes are presented in FIG. 9. The FTIR spectra of three intense bands observed in the case of the nitrocellulose mixed ester membrane (support), which is attributed to various nitrate group vibrations. These peaks appeared at wavelengths of 840 cm⁻¹, 1280 cm⁻¹ and 1660 cm⁻¹, corresponding to the valence NO stretching, symmetric NO₂ stretching and antisymmetric NO₂ stretching, respectively. Moreover, the typical peaks at 1800 cm⁻¹ and 1000 cm⁻¹, correspond to the carbonyl C═O and O—C—O groups of the ester, while the existence of the C—H stretching peak was detected between 2850 and 3000 cm⁻¹.

The in-situ self-polymerization of TA and DA-based NPG membranes including N—H and O—H groups can be observed in the FTIR spectrum presented in FIG. 9. Relative to support, the FT-IR spectra of NPG-pTD1, NPG-pTD2 and NPG-pTD3 membranes have similar peaks besides the huge augmentation of O—H stretching vibrations at 3430 cm⁻¹ as the loading of used pTD-NPG increased and shifting C═O group to 1710 cm⁻¹ and the existence of a new peak of CON—H shown in the range of 1600 to 1650 cm⁻¹. This confirms the hydrogen bonding and π-π stacking formation between the protonated pTA and NPG, in addition to the creation of covalent bonds among pDA and oxygen functional groups of NPG nanosheets, which is beneficial to graft NPG nanosheets onto the surface of support for the successful fabrication of the stable 3D hierarchical NPG-pTDX membranes.

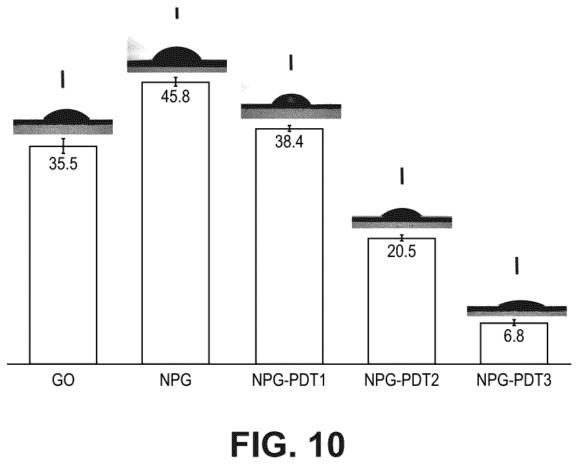

FIG. 10 displays the prepared membranes' hydrophilicity profile. Water contact angles (WCAs) of 35.5 and 45.8 for GO and NPG membranes, respectively, are attributed to the occurrence of more hydrophilic oxygen-reactive groups in the former. While, the NPG membrane displayed less hydrophilicity, due to the major changes in its morphological feature, along with a partial reduction of NPG nanosheets. The wettability profiles of the NPG-pTD1, NPG-pTD2 and NPG-pTD3 membranes were interestingly enhanced as the concentration of utilized NPG-pTD increased, compared to GO and NPG membranes. The results confirm the successful creation of hydrophilic 3D hierarchical NPG-pTDx-based membranes, with more hydrophilic —NH, C═O and —OH functional groups on the fabricated membranes' surface.

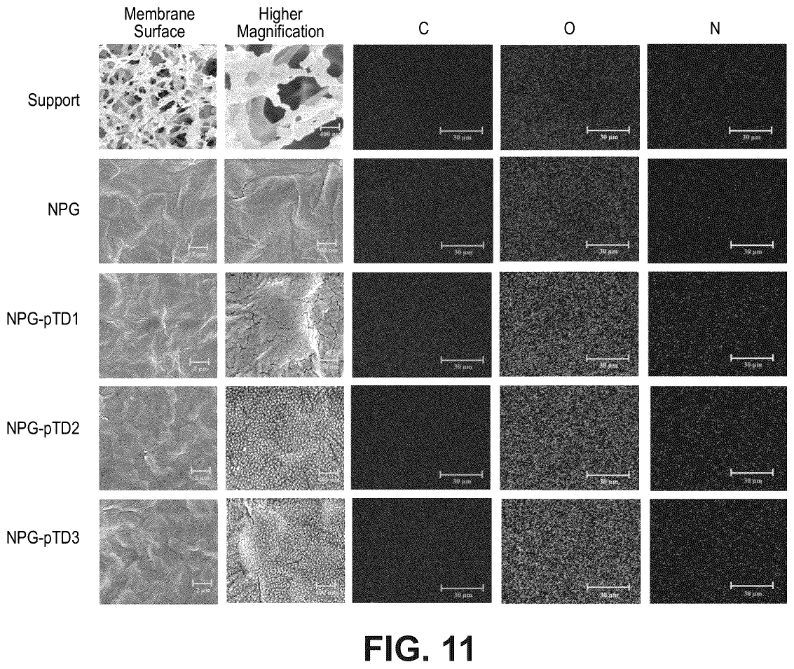

The SEM was used to visualize the surface morphology of the support, NPG and the aquaporin-like 3D hierarchical NPG-pTDX membranes. As shown in FIG. 11, the successful preparation of the NPG and the aquaporin-like 3D hierarchical NPG-pTDX membranes was confirmed. The vacuum filtration technique achieved the full coverage of microporous support using various loadings of NPG and NPG-pTD nanosheets. The SEM images of NPG and NPG-pTD1 membranes displayed a wrinkled surface, due to the interlayer interactions between the NPG or NPG-pTD nanosheets during the fabrication process. The higher loadings of used NPG-pTD in NPG-pTD2 and NPG-pTD3 membranes resulted in the formation of self-assembled 3D hierarchical nanoparticles on the surface via the in-plane interactions. Furthermore, the higher magnification of captured SEM images of the fabricated NPG-pTD2 and NPG-pTD3 membranes proved the formation of self-assembled 3D hierarchical nanoparticles through the in-situ self-polymerization approach, in which the nanoparticles a size between 5-7 nm. Unlike, the higher magnification SEM images of the NPG and NPG-pTD1 membranes showed the nonexistence of 3D hierarchical nanoparticles.

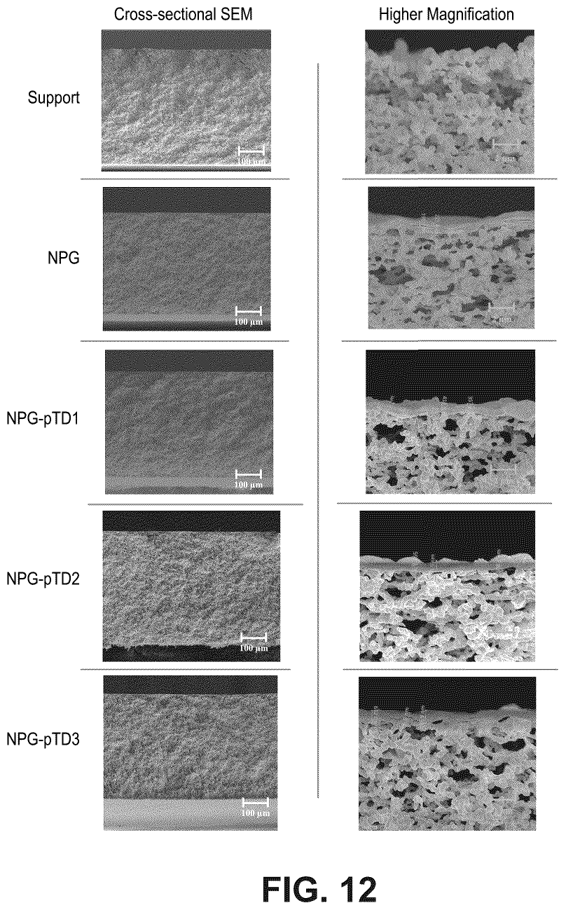

The cross-sectional visualizations of the NPG, NPG-pTD1, NPG-pTD2 and NPG-pTD3 membranes displayed a dense layer with different thicknesses of 211, 386, 535 and 611 nm, respectively, according to the loading increase of utilized NPG-pTD nanosheets (FIG. 12). The SEM images show the stacking of the NPG sheets or nanolayers. The SEM images verified that there was no negative impact on the creation of an identical laminar layer on the top of membranes through the in-situ growth of self-assembled 3D hierarchical NPG-pTD1. Additionally, according to the AFM analysis, a single NPG nano-layer measured 0.8 nm in width. Accordingly, the cross-sectional SEM images of NPG and NPG-pTD1 showed that there were ˜265 and ˜485 nano-layers, respectively. Although using the same loading of NPG and M-NPG, the thickness of the NPG-pTD1 membrane increased by 1.8 times compared to the NPG membrane, which is ascribed to the successful in-situ growth of self-assembled 3D hierarchical pTD1 nanoparticles among the nanosheets or nanolayers of NPG. Additionally, the EDS mapping of the fabricated membranes' surfaces was completed to analyse the elemental compositions as presented in FIG. 11. The EDS mapping confirmed the occurrence of C, O and N in all membranes. The distribution and intensity of this O and N enhanced in NPG-pTD1, NPG-pTD2 and NPG-pTD3 membranes, which can be attributed to the successful intercalation with DA and TA.

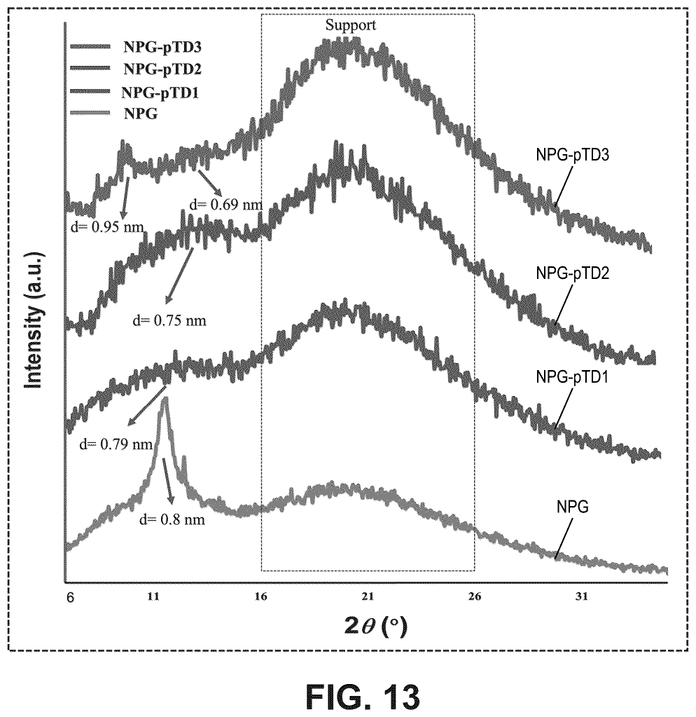

The fabrication approach encompasses two phases; initially, the adherence of DA and TA molecules within the NPG nanosheets via π-π stacking, along with hydrogen bonding, hence the protonated TA and DA can attach to the oxygen functional groups of NPG. In the second stage, complete in-situ polymerization reaction, resulting in the growth of self-assembled 3D hierarchical NPG-pTD after treatment with adjusted tris buffer solution. This unique morphological structure of prepared membranes enhanced the d-spacing from 0.8 to 0.95 nm, due to the formation of aquaporin-like channels. The membrane's efficiency, in terms of selectivity and flux, is controlled by the d-spacing among the NPG and M-NPG nanosheets; in this study, aquaporin-like engineered channels with alternative arrangements were able to achieve both excellent permeability and high selectivity (FIG. 13). The XRD pattern of all NPG, NPG-pTD1 and NPG-pTD2 membranes included d-spacing of 0.8, 0.79 and 0.75 nm according to Bragg's law, while the NPG-pTD3 membrane exhibited a wider d-spacing of 0.95 nm and tight one of 0.69 nm, which can be attributed to the presence of attached self-assembled 3D hierarchical NPG-pTD after treatment with adjusted tris buffer solution (FIG. 13). The output is consistent with the results of the SEM cross-sectional and surface analyses.

### Example 4—Performance Assessment of the 3D Hierarchical NPG-pTDX Membranes

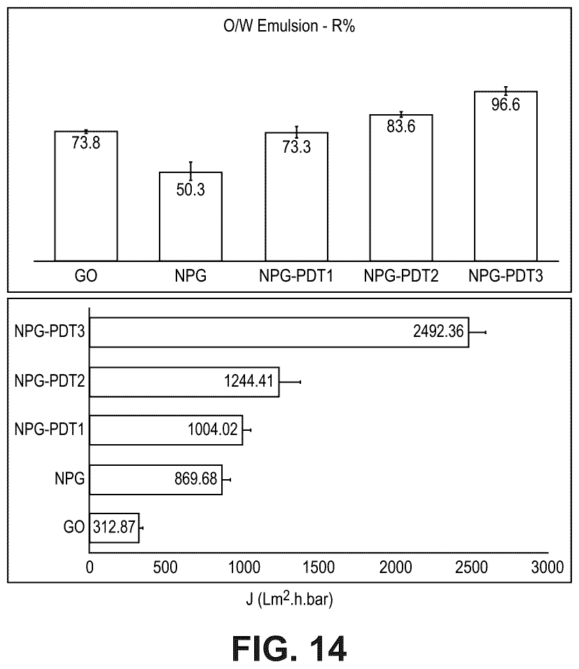

The performance of GO, NPG and the 3D hierarchical NPG-pTDX membranes was assessed via vacuum filtration using water emulsions with surfactant-stabilized oil. As shown in FIG. 14, the fabricated GO membrane exhibited 74% oil in water separation, compared to the NPG membrane has only 50% removal capacity. The permeability performance of GO and NPG membranes was almost 313 and 870 L/m²·h·bar, respectively. The permeability of the GO membrane can be ascribed to the attraction of water to the hydrophilic oxygen reactive groups region of GO nanosheets passing quickly through the hydrophobic graphitic region with almost no resistance. While the key mechanism of the GO membrane's selectivity is ascribed to d-spacing among the stacked nanosheets, which is tighter than the size of the oil nano-emulsion, the swelling issue of GO nanosheets could be the reason for less rejection efficiency.

The NPG membrane was integrated with nanohole arrays (˜11 to ˜20 nm), and distributed through the nanosheet exterior (FIGS. 6A-6D). The rejection capacity of the NPG membrane was less than the GO membrane. Nevertheless, the water penetrability across the NPG membrane is almost 2.8 times the GO membrane, which is ascribed to the combination between direct nanochannels via nanoholes distributed in the nanosheets, along with the d-spacing nanochannels among stacked nanosheets. The d-spacing nanochannels midst the nanosheets of 2D membranes are important as it controls the separation and permeability efficiencies, however, the 2D membranes suffer from permeability/selectivity trade-off challenge. To address this bottleneck, the 3D hierarchical aquaporin-like NPG-pTDX membranes were designed with tripartite nanochannels comprising expansive-compact alternative d-spacing nanochannels intercalated with pTD nanoparticles and the nanochannels of NPG nanosheets.

The oil removal abilities of the NPG-pTD1, NPG-pTD2 and NPG-pTD3 membranes were 73, 84 and 97%, while the permeabilities profile interestingly increases with almost values of 1000, 1244 and 2490 L/m²·h·bar, correspondingly (FIG. 14). The results confirmed the increment of the permeability of membranes as the loading of the hydrophilic pTD increased, which is in agreement with contact angle analysis (FIG. 10). The aquaporin-like NPG-pTD3 membrane had a superior oil removal and ultra-high permeability relative to the other membranes with more than 8 times the permeability of the GO membrane, which is ascribed to the growth of the hydrophilic 3D hierarchical pTD among the NPG nanosheets as shown in FIG. 11. The mechanism of efficient oil removal can be elucidated through the development of a thin water-solid interface layer on the surface of the NPG-pTD3 membrane, which works perfectly to block oil adhesion. The highly uniform self-assembly distribution of the hydrophilic 3D pTD amid the NPG nanosheets through in-situ polymerization reactions generates wide hydrophilic d-spacing regions alternative with tight hydrophobic graphitic regions, which can be considered a key role in oil/water separation (see FIG. 3C).

The examples above confirm that the 3D hierarchical aquaporin-like NPG-pTDX membranes with tripartite nanochannels were successfully prepared, enabling high performance and overcoming the flux/selectivity trade-off. Interestingly, the NPG-pTD3 membrane showed ultra-high permeability of 2490 L/m²·h·bar along with high oil rejection of more than 96%. The practical in-situ polymerization method allowed the formation of expansive/compact alternative d-spacing nanochannels to tailor the chemical and physical structure of the prepared membranes. These engineered membranes feature a one-of-a-kind pattern of an aquaporin-like multi-functionalized NPG that has tremendous potential for treating oily wastewater from different industries.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

### DISCUSSION OF POSSIBLE EMBODIMENTS

The following are non-exclusive descriptions of possible embodiments of the present invention.

According to one aspect, a multi-functionalized NPG nanosheet includes a nanoporous graphene (NPG) nanosheet modified with a polyphenolic and a catecholamine to form the multi-functionalized NPG nanosheet in which the polyphenolic and the catecholamine attach to the NPG nanosheet.

The nanosheet of the preceding paragraph can optionally include, additionally and/or alternatively any, one or more of the following features, steps, configurations and/or additional components.

In some embodiments, the polyphenolic is tannic acid.

In some embodiments, the catecholamine is dopamine hydrochloride.

In some embodiments, a weight ratio of polyphenolic to catecholamine is about 1:1.

In some embodiments, a volume ratio of polyphenolic to NPG nanosheet is between about 100:1 and about 5:1, and a volume ratio of catecholamine to NPG nanosheet is between about 100:1 and about 5:1.

In some embodiments, the volume ratio of polyphenolic to NPG nanosheet is about 100:1.

In some embodiments, the volume ratio of catecholamine to NPG nanosheet is about 100:1.

In some embodiments, the NPG nanosheet is mixed with the polyphenolic and the catecholamine in a tris buffer solution to form the multi-functionalized NPG nanosheet.

In some embodiments, the nanosheet has nanopores with a pore diameter ranging between about 10 nm and about 25 nm.

In some embodiments, the pore diameter is between about 18 nm and about 22 nm.

In some embodiments, a thickness of the nanosheet is about 0.8 nm.

In some embodiments, a lateral dimension of the nanosheet is between about 500 and about 1000 nm.

According to another aspect, an NPG membrane includes a plurality of multi-functionalized NPG nanosheets, the multi-functionalized NPG nanosheets formed by attaching a polyphenolic and a catecholamine to an NPG nanosheet. The plurality of multi-functionalized NPG nanosheets are arranged in a stacked assembly in the membrane. The NPG membrane further includes a plurality of polyphenolic nanoparticles attached to the membrane and among the stacked assembly of multi-functionalized NPG nanosheets.

The membrane of the preceding paragraph can optionally include, additionally and/or alternatively any, one or more of the following features, steps, configurations and/or additional components.

In some embodiments, a loading concentration of the multi-functionalized NPG nanosheets in the membrane is between about 65 and about 225 μg/cm².

In some embodiments, the loading concentration is at least about 150 μg/cm².

In some embodiments, a spacing between adjacent nanosheets in the plurality of multi-functionalized NPG nanosheets is between about 0.65 nm and about 1.0 nm.

In some embodiments, the spacing between adjacent nanosheets includes a hydrophilic channel and a hydrophobic channel in an alternating pattern.

In some embodiments, a thickness of the membrane is between about 200 and about 700 nm.

In some embodiments, the nanoparticles in the plurality of polyphenolic nanoparticles have a diameter ranging between about 4 and about 10 nm.

In some embodiments, the stacked assembly includes between about 250 and about 500 nanosheets.

In some embodiments, the membrane further comprises a permeable support that the plurality of multi-functionalized NPG nanosheets are attached to.

In some embodiments, the permeable support is formed of nitrocellulose.

In some embodiments, the membrane is formed via in situ polymerization and vacuum filtration.

According to another aspect, a method of making an NPG membrane includes arranging a plurality of multi-functionalized nanoporous graphene (NPG) nanosheets into a stack. The NPG nanosheets are functionalized with phenolic compounds. The method further includes forming nanoparticles from the phenolic compounds such that the nanoparticles are attached to the membrane and to the nanosheets.

The method of the preceding paragraph can optionally include, additionally and/or alternatively any, one or more of the following features, steps, configurations and/or additional components.

In some embodiments, the phenolic compounds include tannic acid and dopamine hydrochloride, and the tannic acid and dopamine hydrochloride attach to an oxygen functional group of the NPG nanosheets such that the NPG nanosheets self-stack.

In some embodiments, a volume ratio of polyphenolic to dopamine hydrochloride to the NPG nanosheet is between about 100:100:1 and about 5:5:1.

In some embodiments, arranging the plurality of NPG nanosheets into a stack results in a pattern of hydrophilic interlayer spacing and hydrophobic interlayer spacing between adjacent nanosheets.

In some embodiments, the hydrophilic interlayer spacing is greater than the hydrophobic interlayer spacing.

In some embodiments, forming nanoparticles from the phenolic compounds includes performing in-situ polymerization.

In some embodiments, the method further comprises forming the plurality of NPG nanosheets from graphene oxide.

In some embodiments, the method further comprises etching the graphene oxide to form the plurality of NPG nanosheets.

According to another aspect, a method of using an NPG membrane for oil/water separation includes providing or forming an NPG membrane. The NPG membrane includes a plurality of multi-functionalized NPG nanosheets in a stacked assembly, the multi-functionalized NPG nanosheets formed by attaching a polyphenolic and dopamine hydrochloride to the multi-functionalized NPG nanosheets. The NPG membrane further includes a plurality of polyphenolic nanoparticles attached to the membrane and throughout the stacked assembly. The method further includes exposing an oil/water emulsion to the membrane to remove the oil from the emulsion as the emulsion passes through the membrane.

The method of the preceding paragraph can optionally include, additionally and/or alternatively any, one or more of the following features, steps, configurations and/or additional component.

In some embodiments, removing the oil from oil in water emulsion includes rejecting the oil from passing through the membrane and allowing water to travel through channels in the membrane.

In some embodiments, an oil removal ability of the NPG membrane is at least 70%.

In some embodiments, the oil removal ability is at least 80%.

In some embodiments, the oil removal ability is at least 95%.

In some embodiments, the permeability of the NPG membrane increases as a function of a loading concentration of the multi-functionalized NPG nanosheets in the membrane.

In some embodiments, the loading concentration is between about 65 and about 225 μg/cm².

1. A multi-functionalized NPG nanosheet comprising:
a nanoporous graphene (NPG) nanosheet modified with a polyphenolic and a catecholamine to form the multi-functionalized NPG nanosheet in which the polyphenolic and the catecholamine attach to the NPG nanosheet.

2. The nanosheet of claim 1, wherein the polyphenolic is tannic acid.

3. The nanosheet of claim 1, wherein the catecholamine is dopamine hydrochloride.

4. The nanosheet of claim 1, wherein a weight ratio of polyphenolic to catecholamine is about 1:1.

5. The nanosheet of claim 1, wherein a volume ratio of polyphenolic to NPG nanosheet is between about 100:1 and about 5:1, and a volume ratio of catecholamine to NPG nanosheet is between about 100:1 and about 5:1.

6. The nanosheet of claim 1, wherein the NPG nanosheet is mixed with the polyphenolic and the catecholamine in a tris buffer solution to form the multi-functionalized NPG nanosheet.

7. The nanosheet of claim 1, wherein the nanosheet has nanopores with a pore diameter ranging between about 10 nm and about 25 nm.

8. An NPG membrane comprising:
a plurality of multi-functionalized NPG nanosheets, the multi-functionalized NPG nanosheets formed by attaching a polyphenolic and a catecholamine to an NPG nanosheet, the plurality of multi-functionalized NPG nanosheets arranged in a stacked assembly in the membrane; and
a plurality of polyphenolic nanoparticles attached to the membrane and among the stacked assembly of multi-functionalized NPG nanosheets.

9. The membrane of claim 8, wherein a loading concentration of the multi-functionalized NPG nanosheets in the membrane is between about 65 and about 225 μg/cm².

10. The membrane of claim 9, wherein the loading concentration is at least about 150 μg/cm².

11. The membrane of claim 8, wherein a spacing between adjacent nanosheets in the plurality of multi-functionalized NPG nanosheets is between about 0.65 nm and about 1.0 nm.

12. The membrane of claim 11, wherein the spacing between adjacent nanosheets includes a hydrophilic channel and a hydrophobic channel in an alternating pattern.

13. The membrane of claim 8, wherein the nanoparticles in the plurality of polyphenolic nanoparticles have a diameter ranging between about 4 and about 10 nm.

14. The membrane of claim 8, wherein the stacked assembly includes between about 250 and about 500 nanosheets.

15. The membrane of claim 8, further comprising a permeable support that the plurality of multi-functionalized NPG nanosheets are attached to.

16. A method of making an NPG membrane, the method comprising:
arranging a plurality of multi-functionalized nanoporous graphene (NPG) nanosheets into a stack, the NPG nanosheets functionalized with phenolic compounds; and
forming nanoparticles from the phenolic compounds such that the nanoparticles are attached to the membrane and to the nanosheets.

17. The method of claim 16, wherein the phenolic compounds include tannic acid and dopamine hydrochloride, and the tannic acid and dopamine hydrochloride attach to an oxygen functional group of the NPG nanosheets such that the NPG nanosheets self-stack.

18. The method of claim 17, wherein a volume ratio of polyphenolic to dopamine hydrochloride to the NPG nanosheet is between about 100:100:1 and about 5:5:1.

19. The method of claim 16, wherein arranging the plurality of NPG nanosheets into a stack results in a pattern of hydrophilic interlayer spacing and hydrophobic interlayer spacing between adjacent nanosheets.

20. The method of claim 19, wherein the hydrophilic interlayer spacing is greater than the hydrophobic interlayer spacing.

21. The method of claim 16, wherein forming nanoparticles from the phenolic compounds includes performing in-situ polymerization.
